(19) United States
(12) Patent Application Publication
(10) Pub. No.: US 2011/0121665 A1
(43) Pub. Date: May 26, 2011

(54) POWER SUPPLY APPARATUS

(75) Inventors: Chenyang Liu, Shanghai (CN); Hendrikus Albertus Adrianus Maria de Ruijter, Shanghi (CN); Levinus Pieter Bakker, Shanghai (CN)

(73) Assignee: KONINKLIJKE PHILIPS ELECTRONICS N.V., EINDHOVEN (NL)

(21) Appl. No.: 13/054,552

(22) PCT Filed: Jul. 13, 2009
(86) PCT No.: PCT/IB2009/053022

§ 371 Date: Jan. 17, 2011

(30) Foreign Application Priority Data
Jul. 23, 2008 (CN) 200810142968.2

(51) Int. Cl. H02J 9/00

(52) U.S. Cl. 307/150

(57) ABSTRACT

To solve or mitigate the problem of lacking the “last mile” connection to a power grid, the invention provides a power supply apparatus for supplying electric energy to a plurality of devices. The apparatus comprises a power dock (130) configured to electrically couple to a power pack (110), wherein the power pack is configured to store electric energy; and a plurality of connectors each being configured to supply electric energy from the power dock to one of the plurality of devices (132, 134, 136). By utilizing the power pack, particularly a removable super capacitor (112), accessing power becomes easier for those people living away from power grids or suffering from an unstable power supply.

### FIELD OF THE INVENTION

The present invention relates to apparatus for supplying power to multiple devices, particularly multiple domestic appliances.

### BACKGROUND OF THE INVENTION

Among most countries, an expansive and fixed power grid is built to supply power for commercial and domestic applications. A dedicated power line, also known as “the last mile”, is set up for each house so as to connect it to the core network of the power grid. However, in some developing countries, setting up “the last mile” is quite expensive and time-consuming, particularly for people living in rural areas. For these people, who lack “the last mile” connection, there is the possibility of obtaining power from solar energy systems or wind power systems. However, such systems are normally too expensive for some people to afford. Even when some people have “the last mile” connection with an unstable power grid, they still suffer from the unstable or temporary loss of power supply.

Therefore, there is a need to supply power to people in an easy and economic way.

### OBJECT AND SUMMARY OF THE INVENTION

It is an object of the present invention to provide methods and apparatus for supplying power to people in an easy and economic way, in particular without the need to build up the “last mile” connection.

According to one embodiment of the present invention, a system for transferring electric energy is provided, the system comprising a power pack for storing electric energy; a charger configured to charge the power pack with electric energy; and a power dock configured to electrically couple to the power pack and transfer the electric energy from the power pack to a plurality of devices.

In one embodiment, the power pack preferably comprises a super capacitor or a pseudo capacitor. In another embodiment, the charger is further configured to couple to a power grid, a solar panel, a wind energy generator, or an automotive energy generator.

According to one embodiment of the present invention, an apparatus for supplying electric energy to a plurality of devices is provided, the apparatus comprising a power dock configured to electrically couple to a power pack, wherein the power pack is configured to store electric energy; and a plurality of connectors each being configured to supply electric energy from the power dock to one of the plurality of devices.

This apparatus is particularly helpful in supplying electric energy to a plurality of domestic appliances. The power pack is preferably removable, which means that it can be plugged into and unplugged from the power dock. The power pack is preferably rechargeable by means of, for example, a super capacitor. The power pack can be charged by a power supplier anywhere and at any time, and can be taken back home and supply power to the plurality of devices. This application is helpful in mitigating or solving the problem of lacking a “last mile” connection or of an unstable power supply.

Optionally, the apparatus further comprises a plurality of power conditioners. Each power conditioner converts the output voltage of the power pack to a predefined voltage and outputs it to a corresponding connector coupled to the power conditioner.

Optionally, the apparatus further comprises an energy detector configured to detect the remaining electric energy of the power pack. For example, if the power pack comprises a super capacitor or a pseudo capacitor, the energy detector can detect the capacitance and/or the output voltage of the super capacitor. If the power pack comprises a battery, the energy detector can detect the remaining energy in the battery by using an applicable technique. It is advantageous to use the energy detector to alert a user of the status of the power pack. With the knowledge of the power pack status, it is advantageous for the apparatus to further comprise a user interface and/or a profile storage. The user interface is configured to show the information detected by the energy detector to the user and obtain the user's instruction. The profile storage is configured to comprise a profile containing a preference table of supplying power to one or more devices based on information detected by the energy detector.

Optionally, the apparatus further comprises a selector configured to enable one or more connectors on the basis of information detected by the energy detector, and the profile and/or input instruction from the user.

In one embodiment, the apparatus further comprises an integrated energy storage configured to receive electric energy from the power pack and supply the received electric energy to at least one of the plurality of devices. It is advantageous to supply uninterrupted power to the plurality of devices, even when the power pack is removed from the power dock. The integrated energy storage may be any type of energy storage and supplier, preferably a super capacitor.

For providing more energy and/or a higher output voltage, according to one embodiment, the power dock is further configured to have a slot for a second power pack.

For those people having a solar panel, a wind power generator, and/or an automotive energy generator, it is advantageous for the apparatus to further connect the generated electric energy to the power dock, for charging the power pack or the integrated super capacitor, or for supplying energy to the plurality of devices after being converted by the plurality of power conditioners.

These and other aspects, features and/or advantages of the invention are apparent from and will be elucidated with reference to the embodiments described hereinafter.

### BRIEF DESCRIPTION OF THE DRAWINGS

For a more complete understanding of the present invention and its advantages, it will now be described with reference to the accompany drawing, in which:

FIG. 1 illustrates a system for transferring electric energy according to one embodiment of the present invention.

FIG. 2 illustrates a block diagram of several examples of power supply apparatuses according to several embodiments of the present invention.

### DESCRIPTION OF EMBODIMENTS

To solve or mitigate the problem of lacking “the dedicated last mile connection” from a power grid, the present invention provides an embodiment which comprises a system for transferring electric energy from one place to another, without the need of building the physical dedicated “last mile” connection.

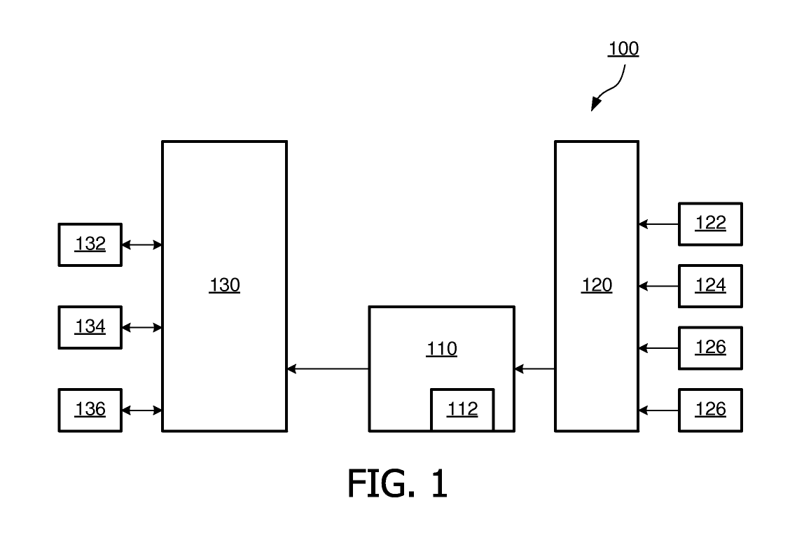

In the embodiment illustrated in FIG. 1, the system 100 comprises a power pack 110, a charger 120 and a power dock 130. The power pack 110 is used for storing electric energy. The power pack 110 may comprise any type of energy storage, such as a battery or a super capacitor. It preferably comprises a super capacitor 112, which has the advantages of “instant charging”, “long cycle life”, “easy-to-take and use”, etc. The charger 120 is configured to charge the power pack with electric energy. The charger 120 can be electrically coupled to the power grid 122 and transforms the alternating current into the direct current so as to charge the power pack 110. It can also receive energy from a solar panel 124, a wind energy generator 126, an automotive energy generator 128, or any other type of energy-generating device. The power dock 130 is configured to electrically couple to the power pack and transfers the electric energy from the power pack to a plurality of devices. The plurality of devices, including a lamp 132, a TV 134, a washing machine 136, etc. are electrically connected to the power dock 130.

When a user wants to get electric energy, he can take the power pack 110 to the charger 120 which may be located far from the user's house. If a super capacitor is comprised in the power pack 110, the charging process can be finished in seconds. If a battery is comprised, the charging process may take tens of minutes to a few hours. After the power pack 110 has been charged with a considerable amount of electric energy, the user takes the power pack 110 back home and connects the power pack 110 to the power dock 130 by way of inserting, screwing, cable-connecting, or any other electrically connection means. The devices electrically connecting to the power dock 130 can be powered on. The problem of lacking the “dedicated last mile connection” is thus fully or partly solved.

For the procedure of transferring electric energy stored in a power pack to devices in a user's house, the present invention provides variant forms and/or functionalities of power supply apparatuses for use in a user's house.

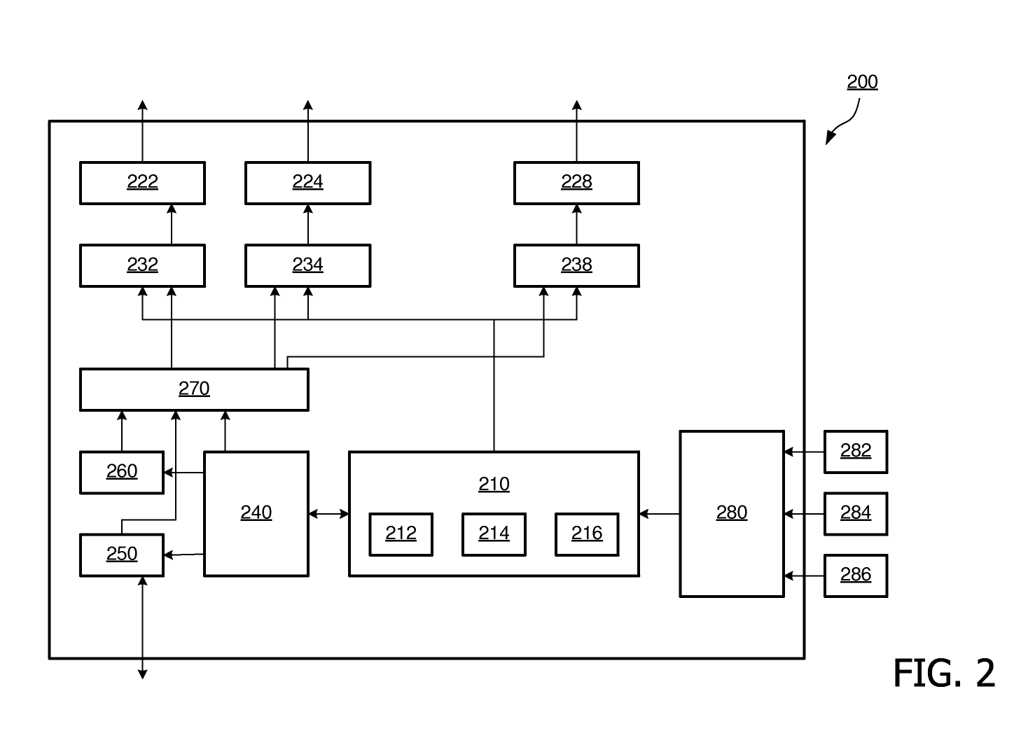

FIG. 2 illustrates several block diagrams of several examples of power supply apparatuses according to several embodiments of the present invention. In FIG. 2, each block represents an individual module or function, and all or part of these blocks can be combined in different combinations to form different embodiments. The purpose of including them in a single Figure is to reduce the number of Figures and to simplify the description. However, this should not be interpreted in such a limiting sense that all embodiments of the present invention comprise all of the modules or functions represented by all blocks in FIG. 2.

According to one embodiment, the power supply apparatus 200 comprises a power dock 210 and a plurality of connectors 222, 224, and 228. The power supply apparatus is configured to supply electric energy to a plurality of devices, especially for domestic appliances, such as lamps, TVs, shavers, mobile phones, torches, etc. The power dock 210 is configured to electrically couple to a power pack 212; the latter is configured to store electric energy. The electrical coupling mode may include forms of plugging, inserting in a slot, screwing, or even simply connecting the power pack 212 to the power dock 210 by using an electric cable. Among the plurality of connectors, each connector 222, 224, 228 is configured to supply electric energy from the power dock to one of the plurality of devices. The connector may be a wall outlet, an elongated cable having one end attached to the housing of the power supply apparatus 200 and the other end electrically connected to an appliance, a socket located at the housing of the power supply apparatus 200, or any other applicable shape.

Use of this example of a power supply apparatus has the advantage that a plurality of devices can be powered on when a power pack is electrically coupled, without the need of a physical connection to the core network of the power grid. Use of this example of a power supply apparatus has the further advantage that the power supply can be organized in a centralized method and that there is no need to configure different power suppliers for different devices. A user can artificially regard the power supply apparatus 200 as the dedicated power line connected to the power grid, so there is no need to change his customary pattern of usage. Another advantage is that the user can easily decide to supply power to one or more envisaged devices by connecting the corresponding connectors.

In another embodiment, particularly for those devices having different operating voltages, a plurality of power conditioners 232, 234, 238 is provided in the power supply apparatus 200. Each power conditioner is further configured to convert the output voltage of the power dock to a corresponding predefined voltage and output it to a corresponding connector electrically coupled to the power conditioner. This embodiment, given by way of example, is advantageous in that it provides different voltages to different devices, such as shavers, lamps, TVs, mobile phones, etc. It is applicable for directly linking the output voltage of the power dock to a device if the output voltage exactly corresponds to the operating voltage of the device.

To monitor the amount of stored energy in the power pack 212, another embodiment comprises an energy detector 240 for detecting the electric energy stored in the power pack. If the power pack comprises a super capacitor, the energy detector 240 can detect the capacitance and/or the output voltage of the power pack 212, and calculate the remaining power. Other suitable energy detection methods are applicable, for example, if the power pack 212 comprises a battery.

In another embodiment, information such as the current output voltage of the power pack, the percentage of remaining power, the need to replace the power pack, and any other useful information detected by the energy detector 240, can be shown to the user through a user interface 250. Furthermore, the user interface 250 is configured to receive instructions from the user so as to control the power supply apparatus 200.

In another embodiment, a profile storage 260 is configured to store a profile containing a preference table of selecting one or more connectors of the plurality of connectors on the basis of information detected by the energy detector.

In a further embodiment, a selector 270 is configured to enable one or more connectors on the basis of information detected by the energy detector, and on the basis of the profile and/or input information through the user interface. For example, when the energy detector 240 detects that the remaining energy, or the output voltage, of the power pack 212 is too low, the information can be shown to the user through the user interface 250. The user may select to turn off the TV and only leave one lamp on. The instruction can be received through the user interface 250 and forwarded to the selector 270. Consequently, the selector 270 will disable the connector, for example, the connector 222 connected to the TV, and enable the connector, for example, the connector 224 connected to the lamp. The user can also pre-store his preference in the profile, for example, by giving the lamp the highest priority, the TV the middle priority, and the shaver the lowest priority. The combination of profile, selector and energy detector can provide the automatic selection without the need of user intervention. The energy detector 240, the user interface 250, the profile storage 260 and the selector 270 can be combined in any form. The connector 270 can directly disable a connector, for example, 222, or a power conditioner, for example, 232.

For providing more energy or a higher output energy, another embodiment of the power dock 210 is further configured to hold a second power pack 214. The power pack 212 and the second power pack 214 are arranged to provide more electric energy or a higher output voltage. The power pack 212 and the second power pack 214 may both comprise a super capacitor.

For providing an uninterrupted power supply to the plurality of devices, or prolonging the operating time of some devices, even when the power pack 212 is removed from the power dock, another embodiment of the power dock 210 may further comprise an integrated energy storage 216. The integrated energy storage is configured to get power from the power pack 212 when the latter is inserted into the power dock 210, and to supply power to the plurality of devices when the power pack 212 is inserted into or disconnected from the power dock 210, depending on the configuration. The integrated energy storage preferably comprises a super capacitor. It may also comprise a battery or any other type of device for storing energy.

The power supply apparatus 200 may further comprise a supplementary power supplier 280 which is configured to convert any one of solar energy, wind energy or automotive energy into electric energy, and supply it to the power dock. For example, the supplementary power supplier 280 may be a solar panel 282, a wind power generator 284, and/or an automotive generator 286. The power supplied from the supplementary power supplier 280 can directly power one or more devices through the power dock 210, or charge the integrated energy storage 216. The solar panel 282, the wind power generator 284 and the automotive generator 286 are shown outside the block of the power supply apparatus 200, but it will be evident to a skilled person that all or part of them can be integrated in the power supply apparatus 200.

It will also be evident to those skilled in the art that various modifications of the method and apparatus according to several embodiments of the invention are possible without departing from the spirit or scope of the invention. Therefore, the protective scope of the invention is not limited to the embodiments described.

The remarks made hereinbefore demonstrate that the detailed description with reference to the drawings illustrates rather than limits the invention. There are numerous alternatives which fall within the scope of the appended claims. Any reference sign in a claim should not be construed as limiting the claim. Use of the verb “comprise” and its conjugations does not exclude the presence of elements or steps other than those stated in a claim. Use of the indefinite article “a” or “an” preceding an element or step does not exclude the presence of a plurality of such elements or steps.

1. An apparatus for supplying electric energy to a plurality of devices, the apparatus comprising:
a power dock configured to electrically couple to a power pack, wherein the power pack is configured to store electric energy; and
a plurality of connectors each being configured to supply electric energy from the power dock to one of the plurality of devices.

2. An apparatus as claimed in claim 1, further comprising:
a plurality of power conditioners each being further configured to convert an output voltage of the power dock to a corresponding predefined voltage and output it to a corresponding connector coupled to the power conditioner.

3. An apparatus as claimed in claim 1, further comprising:
an energy detector configured to detect the electric energy stored in the power pack.

4. An apparatus as claimed in claim 3, further comprising:
a user interface configured to show information detected by the energy detector.

5. An apparatus as claimed in claim 3, further comprising:
a profile storage configured to comprise a profile containing a preference table of selecting one or more connectors of the plurality of connectors on the basis of information detected by the energy detector.

6. An apparatus as claimed in claim 4, further comprising:
a selector configured to enable one or more connectors on the basis of information detected by the energy detector, and on the basis of the profile and/or input information through the user interface, wherein the user interface is further configured to receive the input information from an external means.

7. An apparatus as claimed in claim 1, wherein the power dock further comprises an integrated energy storage configured to receive electric energy from the power pack and supply the received electric energy to at least one of the plurality of devices.

8. An apparatus as claimed in claim 7, wherein the integrated energy storage comprises any one of a super capacitor, a pseudo-capacitor or a battery.

9. An apparatus as claimed in claim 1, wherein the power dock is further configured to hold a second power pack, the power dock and the second power pack being arranged to provide more electric energy or a higher output voltage.

10. An apparatus as claimed in claim 9, wherein each power pack comprises any one of a super capacitor, a pseudo-capacitor or a battery for storing electric energy.

11. An apparatus as claimed in claim 1, further comprising:
a supplementary power supplier configured to convert any one of solar energy, wind energy and automotive energy to electric energy and supply it to the power dock.

12. A system for transferring electric energy, comprising:
a power pack for storing electric energy;
a charger configured to charge the power pack with electric energy; and
a power dock configured to electrically couple to the power pack and transfer the electric energy from the power pack to a plurality of devices.

13. A system as claimed in claim 12, wherein the power pack comprises a super capacitor or a pseudo-capacitor.

14. A system as claimed in claim 12, wherein the charger is further configured to couple to a power grid, a solar panel, a wind energy generator, or an automotive energy generator.
